(19) United States
(12) Patent Application Publication
(10) Pub. No.: US 2009/0303259 A1
(43) Pub. Date: Dec. 10, 2009

(54) Video Drive Scheme for a Cholesteric Liquid Crystal Display Device

(76) Inventors: Amir Ben Shalom, Modiin (IL); Ilan Feldman, Moshav Sitriya (IL); Lahav Langboim, Rehovot (IL); Christopher John Hughes, Reading (GB)

Correspondence Address: Pearl Cohen Zedek Latzer, LLP, 1500 Broadway, 12th Floor, New York, NY, 10036, US

(21) Appl. No.: 11/922,597

(22) PCT Filed: Jun. 19, 2006
(86) PCT No.: PCT/GB2006/002237

§ 371 Date: Aug. 14, 2009

(30) Foreign Application Priority Data
Jun. 23, 2005 (GB) 0512829.3

(51) Int. Cl. G06F 3/038; G09G 3/36

(52) U.S. Cl. 345/690; 345/213; 345/94; 345/89

(57) ABSTRACT

A cholesteric liquid crystal display device (24) comprises three stacked cells (10R, 10G, 10B), each comprising a layer of cholesteric liquid crystal material (19) and an electrode arrangement (13, 14) capable of providing independent driving of a plurality of pixels across the layer of cholesteric liquid crystal material by respective drive signals. The display device has a drive circuit (22) arranged to apply respective drive signals to each pixel in successive cycles of predetermined duration. When providing a high reflectance, the drive signal comprises makes use of drive pulses (50) shaped to drive the pixel into the homeotropic state. When providing a low reflectance, the drive signal includes a number of perturbation pulses (61) which are sufficiently short and sufficiently spaced from each other that the pixel is driven into a transient state having a lower reflectance than the planar state.

The present invention relates to a drive scheme for driving a cholesteric liquid crystal display device for providing a range of grey levels. It is particularly concerned with a drive scheme which may be applied at a rate suitable for video images.

A cholesteric liquid crystal display device is a type of reflective display device having a low power consumption and a high brightness. A cholesteric liquid crystal display device uses one or more cells each having a layer of cholesteric liquid crystal material capable of being switched between a plurality of states. These states include a planar state being a stable state in which the layer of cholesteric liquid crystal material reflects light with wavelengths in a band corresponding to a predetermined colour. In another state, the cholesteric liquid crystal transmits light. A full colour display may be achieved by stacking layers of cholesteric liquid crystal material capable of reflecting red, blue and green light. For driving to display an image, the display device typically has an electrode arrangement capable of providing driving of a plurality of pixels across the layer of cholesteric liquid crystal material by respective drive signals.

Most development of cholesteric liquid crystal displays has concentrated on use of the stable states of the liquid crystal material, these being the planar state providing a high reflectance and the focal conic state providing a low reflectance, as well as range of mixture states providing intermediate reflectances as a result of the liquid crystal material having domains in each of the planar and focal conic states. The use of the stable states provides the advantage of low power consumption as energy is only needed to drive the change of state, whereafter the liquid crystal remains in a stable state displaying an image without consuming power. All current commercially available cholesteric liquid crystal display devices work in this mode of operation.

There are some documents such as U.S. Pat. No. 5,661,533 near video or ultra fast response addressing of cholesteric liquid crystal display devices but they are just fast stable state addressing and drive schemes.

Whilst use of the stable states provides a display device with a good contrast ratio, the contrast ratio is limited by the fact that the focal conic state scatters light and this has a reflectance of the order of 3-4%. It has been reported in J Y Nahm et al., Asia Display 1998 pp 979-982 and in WO-2004/030335 that a higher contrast ratio can be achieved by use of the homeotropic state of the cholesteric liquid crystal material which has a lower reflectance than the focal conic state. Thus use of the homeotropic state as the dark state instead of the focal conic state has the advantages of increasing the contrast ratio and improving the colour gamut.

The present invention is concerned with driving a cholesteric liquid crystal display device at video rates. Video is usually regarded as at least 24 frames per second at which rate the viewer cannot perceive the image changes due to the persistence of vision. This corresponds to a cycle (field) of duration 20 ms. At lower rates, flicker is perceived when the refresh of the image is created by temporal dither slower than the persistence of vision.

The homeotropic state has not been used to improve the contrast ratio in current commercially available displays, but the present invention is based on work performed to make use of the homeotropic state in a cholesteric liquid crystal display device at video rates.

To achieve grey levels, one can use time dithering of the drive pulses used to drive a pixel into the homeotropic state, for example as disclosed in WO-2004/030335. To achieve a dark state, a drive pulse is applied for an entire cycle and thus the pixel has a continuously low reflectance and will appear black if a black background is used. To achieve brighter states, the drive pulse is applied for only part of the cycle and in the remainder of the cycle the pixel relaxes into the planar state in which it has a high reflectance. Due to the persistence of vision, the viewer perceives an average reflection of the pixel over the entire cycle. By varying the amount of time in the homeotropic and planar states, a variable average reflectance can be achieved, thereby providing grey levels.

Such a drive scheme allows a cholesteric display to make use of the homeotropic state to improve the contrast ratio over that achievable by use only of the stable states. However, the present inventors have identified that there is a problem when this drive scheme is applied at video rates, namely that the drive scheme cannot achieve grey levels having a high reflectance. This can be explained as follows.

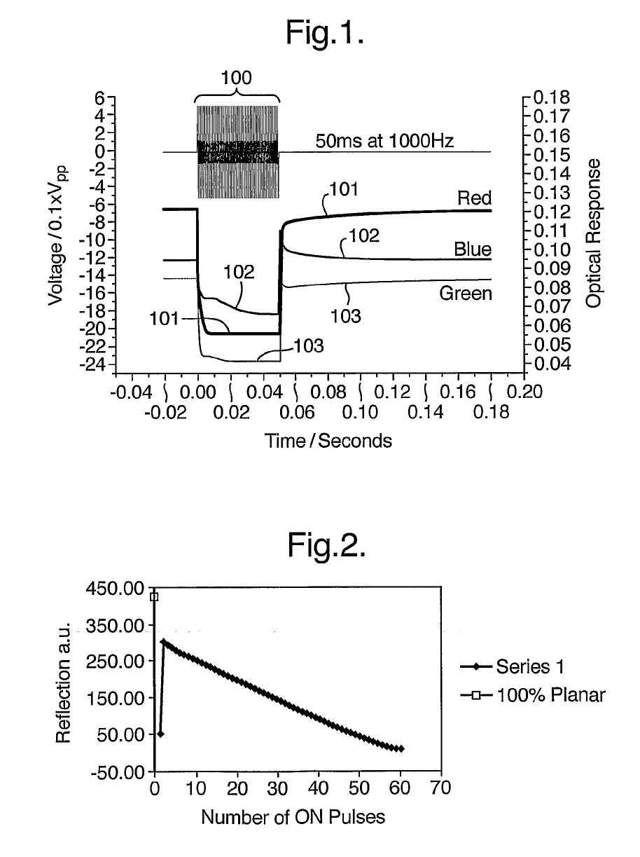

At the end of a drive pulse, the liquid crystal material of a pixel relaxes into the stable planar state. This relaxation occurs over a few ms. This is shown for example in FIG. 1 which is a graph over time of a AC drive pulse 100 (measured on the left hand scale) and the resultant reflectances 101 to 103 of three layers of cholesteric liquid crystal material of different colours (measured on the right hand scale). In each case, the reflectance reduces while the drive pulse 100 drives the liquid crystal material into the homeotropic state and then rises at the end of the drive pulse 100 as the material relaxes into the planar state. The initial rise to a fairly consistent level takes a few milliseconds, although there can subsequently be a relatively small drift in reflectance over a period of the order of 10 ms to 100 ms. The initial rise over a few milliseconds is the time taken for the physical change in the liquid crystal material which involves a change to the stable planar state via a transient metastable planar state having a pitch length of about twice that of the stable planar state.

There is a minimum duration for the drive pulse necessary to drive the pixel from the planar state to the homeotropic state. A drive pulse of this minimum duration provides the pixel with the maximum average reflectance possible with the drive scheme described above making use of both the homeotropic and planar states (this maximum being the average reflection over a cycle as perceived by a viewer). If the drive pulse has a shorter duration than this minimum, the homeotropic state is not reached and the pixel is driven instead to a stable state which is a mixture of domains in the planar state and domains in the focal conic state. The pixel remains in this stable state and has a reflectance which is lower than the maximum average reflectance achieved by the drive scheme making use of both the homeotropic and planar states.

This point can be approximated numerically by taking as an example a cycle duration of 20 ms and a typical time of 3 ms for the transition from the planar state to the homeotropic state then relaxation back to the planar state (although the actual time will depend on the temperature, the voltage used and the parameters of the cell, such as the thickness of the liquid crystal layer and the properties of the liquid crystal material such as viscosity, elastic constant and dielectric anisotropy). In this case, the perceived average reflectance over the cycle is a proportion of (20−3)/20, that is about 75%, of the reflectance of the planar state. In this example it is not possible to achieve grey levels with reflectances between 75% and 100%.

This effect has also been shown experimentally by applying the drive scheme to an actual layer of liquid crystal material. The experiment was performed with a cycle duration of 30 ms and a drive pulse having a duration of a whole number of time slots of duration 0.5 ms. The results are shown in FIG. 2 which is a graph of the resultant average reflectance perceive by a viewer against the duration of the drive pulse measured as a number of time slots. The reflectance of the planar state is also plotted for comparison. As the drive pulse decreased in duration, the perceived reflectance increased monotonically to a value of about 75% of the reflectance of the planar state with a drive pulse of duration 1 ms (i.e. two time slots), but with a drive pulse of duration 0.5 ms (i.e. one time slot) the reflectance fell. This shows it is possible to achieve grey levels varying smoothly over the lower portion of the range but it is not possible to achieve grey levels over the higher portion of the range at all.

By selecting materials with faster switching from the homeotropic state to the planar state and back again, the minimum duration of the drive pulse can be reduced and the maximum reflectance can be increased, but there remains a maximum reflectance which this drive scheme cannot reach. This severely degrades the quality of the image achievable.

One option for increasing the maximum reflectance with this drive scheme is to increase the duration of the cycle. However this is undesirable in itself as it decreases the frame rate and increases the flicker of the image perceived by a viewer.

Another option considered by the present inventors is to double the duration of the cycle in the event that a given pixel requires a grey level above the maximum. Then the time taken for the transition from the homeotropic state to the planar state and back again as a proportion of the overall cycle period is effectively halved and thus the brightness is increased. However this option suffers from problems. Firstly, the implementation whilst possible is complicated, for example requiring a memory to have different read and write periods. Secondly, it can introduce flicker as the pixel is effectively updated at half the rate. Thirdly, artefacts can be introduced when the image is moving because brighter pixels are updated more slowly. Fourthly, although the effective maximum reflectance is increased, there remains a high range of reflectances which cannot be accessed.

Accordingly it would be desirable to develop a drive scheme which allows a cholesteric liquid crystal display device to be driven at video rates whilst allowing pixels to be driven into states having variable high reflectances above that achievable by use of the known drive scheme described above.

Similarly, it would be desirable to develop a drive scheme which allows a cholesteric liquid crystal display device to be driven at video rates whilst allowing pixels to be driven into a full range of reflectances between the reflectance in the planar state and the reflectance in the homeotropic state.

According to the present invention, there is provided a method of driving a cholesteric liquid crystal display device which comprises at least one cell comprising a layer of cholesteric liquid crystal material and an electrode arrangement capable of providing independent driving of a plurality of pixels across the layer of cholesteric liquid crystal material by respective drive signals, the method comprising applying respective drive signals to each pixel in successive cycles of predetermined duration to drive the pixels into states which are varied to provide a reflectance varying within a predetermined range of reflectances,

the drive signal for at least some of the pixels comprises a waveform including a number of perturbation pulses which are of sufficiently low energy and sufficiently spaced from each other that the pixel is driven into a transient state having a lower reflectance than the planar state, the overall energy of the number of the pertubation pulses being variable to provide a varying average reflectance as perceived by a viewer.

This “perturbation drive scheme” is based on an appreciation that a drive pulse of sufficiently short duration and of sufficient spacing from other drive pulses may be applied to pixel in the planar state to drive the pixel into a transient state having a lower reflectance than the planar state. This effect may be observed and measured by applying short, spaced pulses to a layer of liquid crystal material. The transient nature of the effect of reducing the reflectance is evident because the liquid crystal material returns to the planar state after the perturbation pulses cease. The perturbation drive scheme makes use of such pulses to drive a pixel such that over the duration of the cycle the average reflectance of the pixel as perceived by a viewer is in a range of reflectances below that of the planar state.

The number and/or the energy of the perturbation pulses may be varied to alter the average reflectance of the pixel as perceived by the viewer. Most conveniently, the energy is varied by varying the number of the perturbation pulses. In this case, the energy of each pulse may be the same. However, the same effect can be achieved by varying the energy of the perturbation pulses, either with a constant or variable number of pulses.

Furthermore, the perturbation drive scheme may be used to drive the pixel to achieve reflectances above that achievable by a time dithered homeotropic state as described above. Accordingly, the two drive schemes may be applied in combination so that the drive signals comprise within each respective frame:

(a) when providing a reflectance in a first portion of the predetermined range of reflectances, a second waveform comprising

one or more drive pulses shaped to drive the pixel into the homeotropic state,

alternating with one or more relaxation periods to cause the pixel to relax into the planar state, the periods of time during which the pixel is driven into the homeotropic and planar states being variable to provide a varying average reflectance as perceived by a viewer; and

(b) when providing a reflectance in a second portion of the predetermined range of reflectances above the first portion, said first mentioned waveform.

Such a combination of drive schemes allows the cholesteric liquid crystal display device to be driven at video rates whilst simultaneously achieving grey levels over a full range between the reflectances of the planar and homeotropic states. By use of the homeotropic state it is possible to achieve an improved contrast and colour gamut as compared to the use of a static drive scheme which uses the focal conic state as the dark state.

As mentioned above, the electrode arrangement is capable of providing independent driving of a plurality of pixels. The reason for this is the use of the homeotropic state which requires the continuous application of a drive signal. The electrode arrangement may be of any type which allows this.

The preferred electrode arrangement includes a respective conductive layer on each side of the layer of liquid crystal material, with at least one of the conductive layers being patterned to provide a plurality of separate drive electrodes each capable of providing independent driving an area of the layer of liquid crystal material adjacent the respective drive electrode as one of said pixels. This electrode arrangement has the advantage of simplicity, particularly if one of the conductive layers is patterned to provide said plurality of separate drive electrodes and the other of the conductive layer is shaped as at least one common electrode extending over a plurality of pixels.

To allow the application of the drive signals to the drive electrodes, the electrode arrangement may further comprise a separate track connected to each of the separate drive electrodes and extending to a position outside the array of addressable pixels where the tracks form terminals each capable of receiving a respective drive signal. The provision of tracks in the same conductive layer as the drive electrodes has the advantage of being a simple structure which is straightforward to manufacture as the tracks may be formed in the same manufacturing step as the drive electrodes, for example in a lithographic process. Furthermore connection to the tracks may easily be made at the edges of the display device and operation is straightforward because it merely requires application of drive signals to the tracks.

The provision of such tracks does have the effect of reducing the contrast ratio. This is because gaps must be left between the pixels to accommodate all the tracks and these gaps decrease the contrast ratio as the liquid crystal in the gaps is not driven. The problem gets worse as the number of pixels increases. However it has been appreciated that this problem is less acute for display devices having relatively large pixels. The size of the gaps between the pixels needed to accommodate the tracks is fixed for a given number and configuration of drive electrodes and tracks. Thus the fill factor, that is the ratio of the total area of the pixels to the viewing area of the display device including the pixels and the gaps, is reduced as the area of the pixels decreases. This means that the reduction in the contrast ratio caused by the gaps reduces as the size of the pixels increases. It has been appreciated that based on this effect it is possible to achieve acceptable contrast ratios using direct addressing when applied to display devices having relatively large pixels. For example, on average the area is at least 4 mm², more usually at least 25 mm².

According to a second aspect of the present invention, there is provided a cholesteric liquid crystal display device having a drive circuit arranged to apply a respective drive signal to each pixel in accordance with the method described above. In this case the drive circuit may be operable to select the drive scheme to be applied to each pixel in accordance with image data applied thereto.

To allow better understanding, an embodiment of the present invention will now be described by way of non-limitative example with reference to the accompanying drawings, in which:

FIG. 1 is a graph of a drive pulse applied to three layers of cholesteric liquid crystal material and the resultant reflectances;

FIG. 2 is a graph of the perceived reflectance of a layer of liquid crystal material to which a drive pulse of variable duration is applied over a cycle;

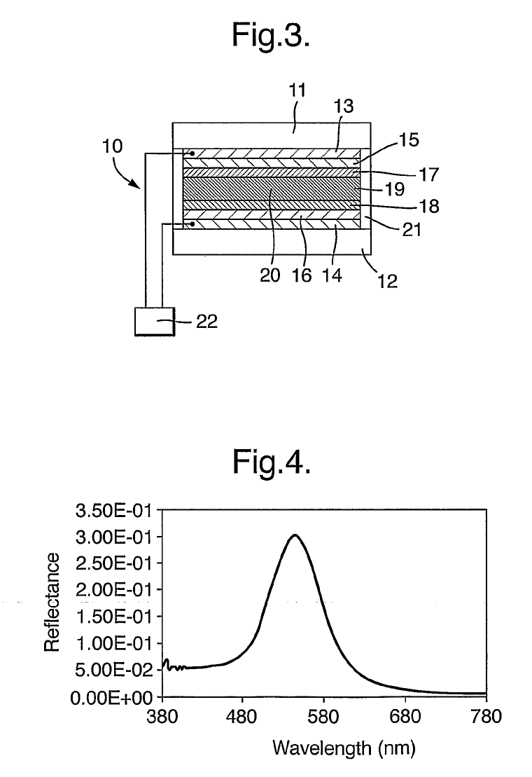

FIG. 3 is a cross-sectional view of a cell of a cholesteric liquid crystal display device;

FIG. 4 is a graph of a typical reflectance spectrum of green cholesteric liquid crystal in the planar state;

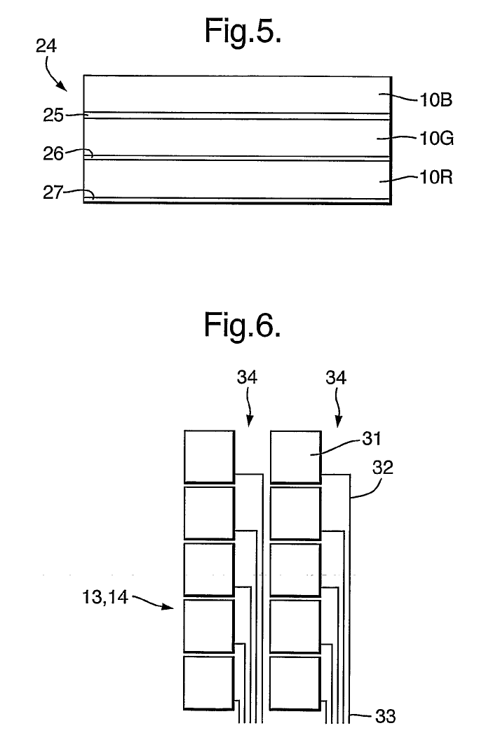

FIG. 5 is a cross-sectional view of the cholesteric liquid crystal display device;

FIG. 6 is a plan view of the electrode arrangement of a conductive layer of the cell of FIG. 5;

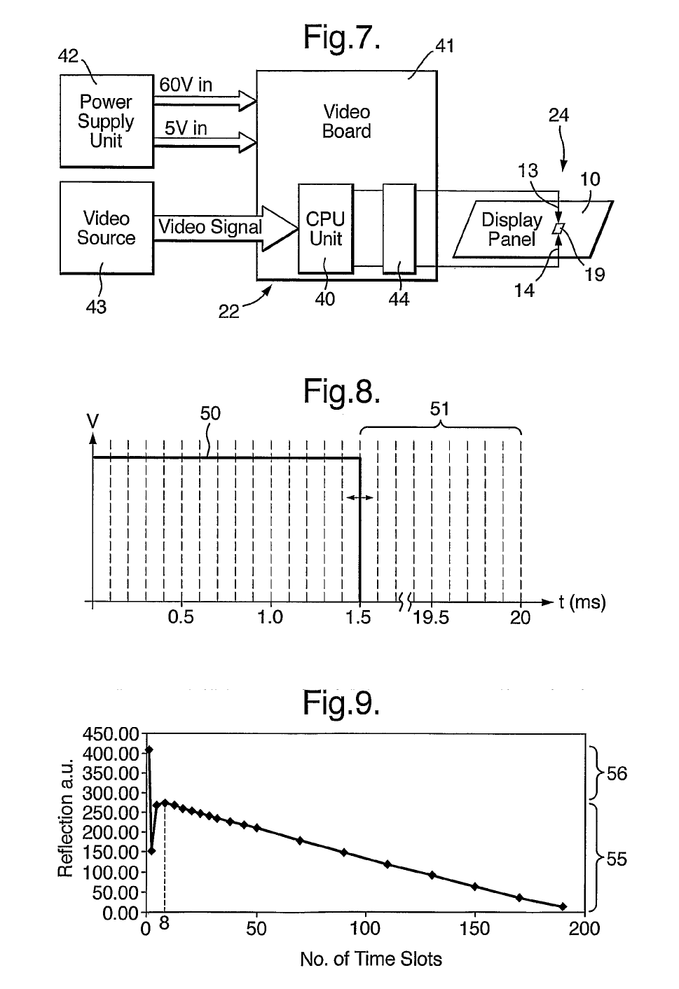

FIG. 7 is a diagram of the control circuit of the display device;

FIG. 8 is a graph of a drive signal in accordance with a homeotropic drive scheme;

FIG. 9 is a graph of reflectance against the duration of the drive pulse with the homeotropic drive scheme of FIG. 8;

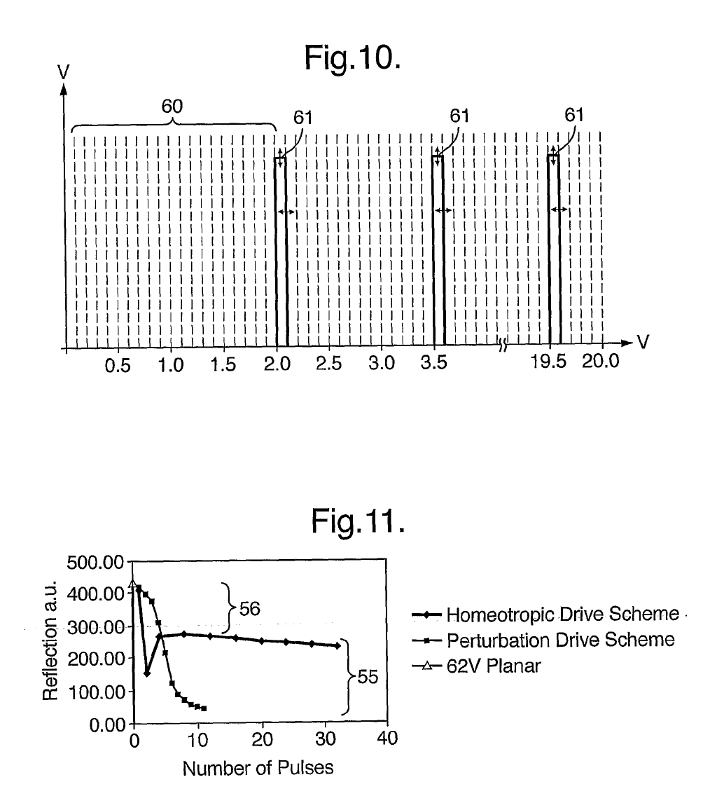

FIG. 10 is a graph of a drive signal in accordance with a perturbation drive scheme; and

FIG. 11 is a graph of reflectance against the duration of the drive pulse with the perturbation drive scheme of FIG. 10.

FIG. 3 shows a single cell 10 which may be used in the cholesteric liquid crystal display device 24. The cell 10 has a layered construction, the thickness of the individual layers 11-19 being exaggerated in FIG. 3 for clarity.

The cell 10 comprises two rigid substrates 11 and 12, which may be made of glass or preferably plastic. The substrates 11 and 12 have, on their inner facing surfaces, respective transparent conductive layers 13 and 14 formed as a layer of transparent conductive material, typically indium tin oxide. The conductive layers 13 and 14 are patterned to provide a rectangular array of addressable pixels, as described in more detail below.

Optionally, each conductive layers 13 and 14 is overcoated with a respective insulation layer 15 and 16, for example of silicon dioxide, or possibly plural insulation layers.

The substrates 11 and 12 define between them a cavity 20, typically having a thickness of 3 μm to 10 μm. The cavity 20 contains a liquid crystal layer 19 and is sealed by a glue seal 21 provided around the perimeter of the cavity 20. Thus the liquid crystal layer 19 is arranged between the conductive layers 13 and 14.

Each substrate 11 and 12 is further provided with a respective alignment layer 17 and 18 formed adjacent the liquid crystal layer 19, covering the respective conductive layer 13 and 14, or the insulation layer 15 and 16 if provided. The alignment layers 17 and 18 align and stabilise the liquid crystal layer 19 and are typically made of polyamide which may optionally be unidirectionally rubbed. Thus, the liquid crystal layer 19 is surface-stabilised, although it could alternatively be bulk-stabilised, for example using a polymer or a silica particle matrix. In this case, the stabilisation is used to optimise the brightness of the planar state.

The liquid crystal layer 19 comprises cholesteric liquid crystal material. Such material has several states in which the reflectivity and transmissivity vary. These states are the planar state, the focal conic state and the homeotropic (pseudo nematic) state, as described in I. Sage, Liquid Crystals Applications and Uses, Editor B Bahadur, vol 3, page 301, 1992, World Scientific, which is incorporated herein by reference and the teachings of which may be applied to the present invention.

In the planar state, the liquid crystal layer 19 selectively reflects a bandwidth of light that is incident upon it. The wavelengths λ of the reflected light are given by Bragg's law, ie λ=nP, where wavelength λ of the reflected wavelength, n is the refractive index of the liquid crystal material seen by the light and P is the pitch length of the liquid crystal material. Thus in principle any colour can be reflected as a design choice by selection of the pitch length P. That being said, there are a number of further factors which determine the exact colour, as known to the skilled person. The planar state is used as the bright state of the liquid crystal layer 19.

Not all the incident light is reflected in the planar state. In a typical full colour display device 24 employing three cells 10, as described further below, the total reflectivity is typically of the order of 30%. The light not reflected by the liquid crystal layer 19 is transmitted through the liquid crystal layer 19. The transmitted light is subsequently absorbed by a black layer 27 described in more detail below.

The reflectance spectrum of the liquid crystal layer 19 in the planar state is shown in FIG. 4 for the example of reflection of green light. The reflectance spectrum has a central band of wavelengths in which the reflectance of light is substantially constant. This is due to the birefringence of the cholesteric liquid crystal material of the liquid crystal layer 19 and corresponds to reflection of light at different angles relative to the ordinary and extraordinary axes, the light at each angle seeing a different refractive index, which causes a different wavelength λ to be reflected.

In the focal conic state, the liquid crystal layer 19 is, relative to the planar state, transmissive and transmits incident light. Strictly speaking, the liquid crystal layer 19 is mildly light scattering with a small reflectance, typically of the order of 3-4%. As light transmitted through the liquid crystal layer is absorbed by the black layer 27 described in more detail below, this state is perceived as darker than the planar state.

In the homeotropic state, the liquid crystal layer 19 is even more transmissive than in the focal conic state, typically having a reflectance of the order of 0.5-0.75%. Use of the homeotropic state has the advantage of increasing the contrast ratio, as compared to use of the focal conic state.

A control circuit 22 supplies a drive signal to the conductive layers 13 and 14 which consequently apply the drive signal across the liquid crystal layer 19 to switch it between its different states. The actual form of the drive signal is described in more detail below, but two general points are to be noted.

Firstly, the focal conic and planar states are stable states which can coexist when no drive signal is applied to the liquid crystal layer 19. Furthermore, the liquid crystal layer 19 can exist in stable states in which the different domains of the liquid crystal material are each in a respective one of the focal conic state and the planar state. A range of such stable states is possible with different mixtures of the amount of liquid crystal in each of the focal conic and planar states so that the overall reflectance of the liquid crystal material varies across the stable states.

Secondly, the homeotropic state is not stable and so maintenance of the homeotropic state requires continued application of a drive signal.

FIG. 5 shows the display device 24 which comprises a stack of cells 10R, 10G and 10B, each being a cell 10 of the type shown in FIG. 3 and described above. The cells 10R, 10G and 10B have respective liquid crystal layers 19 which are arranged to reflect light with colours of red, green and blue, respectively. Thus the cells 10R, 10G and 10B will thus be referred to as the red cell 10R, the green cell 10G and the blue cell 10B. Selective use of the red cell 10R, the green cell 10G and the blue cell 10B allows the display of images in full colour, but in general a display device could be made with any number of cells 10, including one.

In FIG. 5, the front of the display device 24 from which side the viewer is positioned is uppermost and the rear of the display device 24 is lowermost. Thus, the order of the cells 10 from front to rear is the blue cell 10B, the green cell 10G and the red cell 10R. This order is preferred for the reasons disclosed in West and Bodnar, “Optimization of Stacks of Reflective Cholesteric Films for Full Color Displays”, Asia Display 1999 pp 20-32, although in principle any other order could be used.

The adjacent pair of cells 10R and 10G and the adjacent pair of cells 10G and 10B are each held together by respective adhesive layers 25 and 26.

The display device 24 has a black layer 27 disposed to the rear, in particular by being formed on a rear surface of the red cell 10R which is rearmost. The black layer 27 may be formed as a layer of black paint. In use, the black layer 27 absorbs any incident light which is not reflected by the cells 10R, 10G or 10B. Thus when all the cells 10R, 10G or 10B are switched into a transmissive state, the display device appears black.

The display device 24 is similar to the type of device disclosed in WO-01/88688 which is incorporated herein by reference and the teachings of which may be applied to the present invention.

In each cell 10, the conductive layers 13 and 14 are patterned to provide an electrode arrangement which is capable of providing independent driving of a rectangular array of pixels across the liquid crystal layer 19 by different respective drive signals. In particular, the electrode arrangement is provided as follows.

A first one of the conductive layers 13 or 14 (which may be either of the conductive layers 13 or 14) is patterned as shown in FIG. 6 and comprises a rectangular array of separate drive electrodes 31. The other, second one of the conductive layers 13 or 14 extends over the area opposite the entire array of drive electrodes 31 and thus acts as a common electrode or alternatively can be sub-divided.

The first one of the conductive layers 13 or 14 further comprises separate tracks 32 each connected to one of the drive electrodes 31. Each track 32 extends from its respective drive electrode 31 to a position outside the array of drive electrodes 31 where the track forms a terminal 33. The control circuit 22 makes an electrical connection to each of the terminals 33 and a common connection to the second one of the conductive layers 13 or 14. Through this connection, the control circuit 22 in use supplies a respective drive signal to each terminal 33 and thus the respective drive signals are supplied via the tracks 32 to the respective drive electrodes 31. In this manner, each drive electrode 31 independently receives its own drive signal and drives the area of the liquid crystal layer 19 adjacent that drive electrode 31, which area of the liquid crystal layer 19 acts as a pixel. In this manner, an array of pixels is formed in the liquid crystal layer 19 adjacent the array of drive electrodes 31. As each drive electrode 31 receives a drive signal independently, each of the pixels is directly addressable.

Such direct addressing of each pixel is advantageous as compared to passive multiplexed addressing which is commonly used in cholesteric liquid crystal displays. This for a number of reasons as follows.

Firstly, the direct addressing allows each pixel to receive a different drive signal simultaneously. This allows the use of the homeotropic state which requires continuous application of a drive signal. With passive multiplexed addressing, this is not possible as only a single line can be addressed at any one time. Thus the lines which are not being addressed relax rapidly into the planar state.

Secondly, the electro-optic performance of the liquid crystal is improved because each pixel can be addressed independently without affecting or influencing the neighbouring pixels. Also, direct addressing allows compensation of non-uniformity in the parameters of the cell over the area of the display device, for example variation in thickness of the liquid crystal layer due to the manufacturing process, or temperature variation across the display device. Each pixel can be driven with a drive signal adapted, for example by varying parameters such as voltage or pulse duration to compensate those variations.

To accommodate the tracks 32 in the first one of the conductive layers 13 or 14, the drive electrodes 31 are arranged in lines (extending vertically in FIG. 6) with a gap 34 between each adjacent line of drive electrodes 31. The tracks 32 connected to a single line of drive electrodes 31 all extend along one of the gaps 34. All the tracks 32 from each drive electrode 31 in the line of drive electrodes 31 exit the array of drive electrodes 31 on the same side, that is lowermost in FIG. 6. As a result, all of the terminals 33 are formed on the same side of the display device 24. This has particular advantage when a plurality of identical display devices 24 are tiled to provide a larger image area because it reduces the gap needed between the individual display devices 24. Terminals for the common electrode may be provided in a conventional manner, for example using Z-shorts.

The display device 24 has a relatively large area and is intended to provide a relatively large viewing distance, for example for use outdoors or in a large public space such as a building or a transport node. As such, the pixels and drive electrodes 31 are of a relatively large area, for example at least 4 mm² or more preferably at least 25 mm², a typical area being of the order of 80 mm². Each of the drive electrodes 31 is of the same area and is typically square. It has been appreciated that the use of direct addressing in the display device 24 causes a lesser reduction in the contrast ratio than would occur if direct addressing was applied to a display device of smaller size, for example as used as a computer monitor or a television. This results from the fact that the width and spacing of the tracks 34 is fixed. Accordingly for a given number of pixels along the dimension which is vertical in FIG. 3, the width of the gap 34 needed to accommodate the tracks 32 is fixed. Thus, the fill factor, which is the ratio of the total area of the pixels adjacent the drive electrodes 31 to the total viewing area of the display device 24 including the drive electrodes 31 and the gaps 34, reduces as the size of the drive electrodes 31 decreases. This means that the reduction in the contrast ratio caused by the gaps 34 reduces as the size of the drive electrodes 31 increases. Based on this effect, it has been appreciated that for the display device 24 having pixels of a relatively large area, it is still possible to achieve an acceptable contrast ratio with the use of direct addressing.

For clarity FIG. 6 illustrates the drive electrodes 31 and tracks 32 of only two lines of five pixels. The actual display device 24 may comprise a different number of pixels, more typically 36 lines of 18 pixels or larger. Most useful display devices will have at least three or preferably at least five pixels in each dimension.

The control circuit 22 is further illustrated in FIG. 5. The control circuit 22 is formed by a CPU unit 40 mounted on a video board 41 which is a printed circuit board.

The video board 41 receives power from a power supply unit 42, in particular a 5V supply which the video board 41 supplies to the CPU unit 40 and a 60V supply which is used to generate drive signals for the display device 24.

The CPU unit 41 receives an image signal representing an image from a video source 43. The image signal is updated at a video rate and is typically in LCD format or LVDS format. The CPU unit 41 processes the image signal in real time and derives a drive signal for each of the pixels of each of the cells 10R, 10G and 10B in accordance with the image signal to cause the display device 24 to display the image by switching the liquid crystal material of each pixel into a state having an appropriate reflectance. The output drive signals are at a video rate but are not necessarily at an identical rate to the image signal. The drive signals are amplified by an amplifier block 44 on the video board 41 using the 60V source and are supplied to respective pixels of the cells 10R, 10G and 10B.

The form of the drive signals is as follows.

In a typical image, some of the pixels will be in a full bright state, some in a grey level and some in a fully dark state. Thus it is necessary to drive the pixels in each cell 10R, 10G and 10B into a range of reflectances, depending on the image signal. For different portions of the range of reflectances, drive signals of two different forms are generated. In particular, in a first portion of the range of reflectances of lower reflectance, a drive signal is generated in accordance with a homeotropic drive scheme, whereas in a second portion of the range of reflectances of lower reflectance than the first portion, a drive signal is generated in accordance with a perturbation drive scheme. The homeotropic drive scheme and the perturbation drive scheme will now be described in detail.

The drive signals of each of the homeotropic drive scheme and the perturbation drive scheme are applied in successive cycles of predetermined duration. The same cycle is used for both the homeotropic drive scheme and the perturbation drive scheme. The cycle duration is chosen to provide a video frame rate. Usually the cycle duration is at most 30 ms, more preferably at most 20 ms.

The homeotropic drive scheme has a similar basis to the drive scheme disclosed in WO-2004/030335, the disclosure of which may be applied to the present invention and the contents of which are incorporated herein by reference.

The homeotropic drive scheme makes use of driving the pixel into the homeotropic state. To achieve variable reflectances, that is grey levels, the homoetropic drive scheme makes use of time dithering, in which the pixel is driven first into the homeotropic state and then allowed to relax into the planar state, the periods of time during which the pixel is driven into the homeotropic and planar states being variable. In particular, the cycle is divided in a plurality of time slots of predetermined duration and the drive signal comprises a drive pulse occupying a variable number of time slots. Preferably the drive pulse occupies the initial time slots of each cycle. The remaining time slots have no drive pulse and so constitute a relaxation period during which the pixel relaxes into the planar state.

An example of a drive signal in accordance with the homeotropic drive scheme is shown in FIG. 8 which is graph of voltage over time. In this example the duration of the cycle is 20 ms and the duration of the time slots is 0.1 ms, as shown by the dotted lines. FIG. 8 shows a drive pulse 50 occupying 15 time slots and hence having a duration of 1.5 ms. Accordingly, there is a relaxation period 51 of duration 18.5 ms in this example. In general, the drive pulse 50 could occupy any number of time slots as indicated schematically by the arrow. In principle the duration of the drive pulse 50 could vary continuously but the discrete variation using the time slots facilitates a digital implementation.

During the drive pulse 50 the pixel has a low reflectance whereas during the relaxation period 51 the pixel has a high reflectance. Due to the persistence of vision, the viewer perceives an average reflectance of the pixel over the duration of the cycle. This average reflectance varies as the duration of the drive pulse 50 and the relaxation period 51 vary, and so grey levels are achieved. The cycle duration is chosen to minimise any flicker of the pixels as they alternate between the homeotropic and planar states. To provide the minimum reflectance, the drive pulse 50 has the duration of the entire cycle so there is no relaxation period 51. This is not essential and there could always be a relaxation period 51 but this is not preferred as it reduces the minimum reflectance and hence reduces the contrast ratio achievable.

In general, the optimal amplitude of the drive pulse 50 varies in dependence on a number of parameters such the actual liquid crystal material used, the configuration of the cell 10, for example the thickness of the liquid crystal layer 19, and other parameters such as temperature. As is routine in cholesteric liquid crystal display devices, the amplitude can be optimised experimentally for any particular display device 24. Typically, the drive pulse 50 might have an amplitude of 50V to 60V.

The example drive signal of FIG. 8 was applied to an actual liquid crystal cell 10 and the resultant reflectance was measured. The results are plotted in FIG. 9 which is graph of the measured reflectance against the duration of the drive pulse 50 measured as a number of time slots. For comparison, it can be noted that the actual liquid crystal cell had a reflectance in the planar state of about 410 a.u. It can be seen from FIG. 8 that for a drive pulse of duration 0.8 ms or more, as the duration of the drive pulse decreases the reflectance increases monotonically from a reflectance of nearly zero to a reflectance of about 275 a.u., that is about 67% of the reflectance of the planar state. Thus in this example the homeotropic drive scheme allows achievement of reflectances in the range from 0% to 67% of the reflectance of the planar state by use of drive pulses of 0.8 ms or more.

In general the homeotropic drive scheme may be applied with drive pulses of a predetermined minimum duration or more to achieve reflectances in a lower portion 55 of the range from the reflectance of the homeotropic state to the reflectance of the planar state. The actual numerical values of the minimum duration of the drive pulse and the range of reflectance will vary depending on the temperature and parameters of the cell 10, but they can be determined experimentally in a similar manner to the derivation of FIG. 9 as described above.

Whilst the drive signal shown in FIG. 8 comprises a single drive pulse at the beginning of the cycle and a single relaxation period 51 at the end of the cycle, in general more than one drive pulse can be used alternating within each cycle with relaxation periods. For example, one option is for a drive pulse at the start and end of each cycle and a single relaxation period therebetween. There is a limitation that each drive pulse must be sufficient to drive the pixel into the homeotropic state, rather than the focal conic state.

Increasing the number of drive pulses in each cycle can have the advantage of reducing the perception to the viewer of flicker because the periods of time spent in the homeotropic and planar states reduces relative to the persistence of vision. This must be balanced against the detrimental effect that increasing the number of pulses can change the colour gamut. This effect arises because the relaxation of the pixel from the homeotropic state to the stable planar state is a complex process and proceeds via a metastable transient planar state that has about twice the pitch length of the stable planar state (in fact the pitch of transient planar texture is equal to K33/K22×the pitch of final planar state where K33 is the liquid crystal bend elastic constant and K22 is the twist elastic constant). This is known in itself and is explained for example in D-K Yang & Z-J Lu, SID Technical Digest page 351, 1995 and in J Anderson et al, SID 98 Technical Digest, XX1X page 806, 1998. The increased pitch length means that colour of the reflected light differs while the transient planar state persists, thereby changing the colour gamut of the pixel. This effect increases as the number of drive pulses increases and hence the period of time spent in the transient planar state increases relative to the duration of the cycle.

However, FIG. 9 also demonstrates that the homeotropic drive scheme cannot achieve reflectances in an upper portion 56 of the range of reflectances between the reflectances of the homeotropic and planar states. If the duration of the drive pulse is reduced below the minimum, that is 0.8 ms in the example of FIG. 9, then the reflectance actually falls. This is believed to be because the drive pulse is insufficient to drive the pixel into the homeotropic state and instead drives the pixel into stable state which is a mixture of domains in the planar state and domains in the focal conic state. This stable state persists for the duration of the cycle and giving the pixel a lower reflectance.

This problem has been overcome by development of the perturbation drive scheme as follows.

The perturbation drive scheme is based on an appreciation that a drive pulse of sufficiently low energy and of sufficient spacing from other drive pulses may be applied to pixel in the planar state to drive the pixel into a transient state having a lower reflectance than the planar state. Such pulses will be referred to as perturbation pulses. The perturbation drive scheme makes use of such perturbation pulses to drive the pixel such that over the duration of the cycle the average reflectance of the pixel as perceived by a viewer is in a second portion 56 of the range of reflectances above the first portion 55 of the range of reflectances achieved by the homeotropic drive scheme. In particular the perturbation drive scheme is to use a drive signal comprising a relaxation period sufficient to cause the pixel to relax into the planar state followed by a number of such perturbation pulses.

An example of the waveform of such a perturbation drive scheme is shown in FIG. 10 which is a graph of voltage over time. In this example, the cycle has a duration of 20 ms as in the example of the homeotropic drive scheme of FIG. 8. Similarly, the cycle is divided into a plurality of time slots of predetermined duration, in this example of 0.1 ms as in the example of the homeotropic drive scheme of FIG. 8.

For a relaxation period 60 at the beginning of the cycle, there are no perturbation pulses 61. In this example, the relaxation period 60 is of duration twenty time slots, that is 2.0 ms. The relaxation period 60 is applied because the pixel can sometimes be in the homeotropic state at the beginning of a frame. This occurs if the image signal requires that the previous state of the pixel is to have the minimum reflectance. This also occurs if the image signal requires that the previous state of the pixel is to have a reflectance below the minimum when using an alternative homeotropic drive scheme employing drive pulses at the end of a cycle. The relaxation period 60 ensures that the pixel always relaxes into the planar state before application of a perturbation pulse 61.

In general, the duration of the relaxation period 60 necessary to allow the relaxation depends on temperature and the parameters of the display device 24, for example the properties of the cholesteric liquid crystal material. However, the duration may easily be determined by testing of a given liquid crystal cell 10 in given conditions with relaxation periods 60 of different durations. For a typical liquid crystal cell, the relaxation period might have a duration of at least 2.0 ms or at least 3.0 ms,

However, the relaxation period 60 is not essential. The pixel is most normally in the planar state at the start of a cycle because this occurs if the pixel was driven in the previous cycle with the homeotropic drive scheme finishing with a relaxation period or if the pixel was driven in the previous cycle with the perturbation period. In this situation the relaxation period 60 has no effect. Even if the pixel is not in the planar state at the start of a cycle because the pixel was driven in the previous cycle with the homeotropic drive scheme finishing with a drive pulse, the actual effect of omitting the relaxation period 60 does mean that a slightly different reflectance is perceived by the viewer but this only occurs as the image is changing and so does not noticeably degrade the quality of the viewed image.

In the remainder of the cycle after the relaxation period 60, there are a number of perturbation pulses 61, although the positions and durations of the perturbation pulses shown in FIG. 10 are merely exemplary and are indeed may be varied to achieve variable reflectances.

Each perturbation pulse 61 is of sufficiently low energy and sufficiently spaced from the other perturbation pulses 61 that they have the effect of driving the pixel into a transient state having a lower reflectance than the planar state. The precise physical phenomenon occurring to the liquid crystal material of the pixel is not entirely understood, but this effect is based on the actual observation that short, spaced drive pulses do indeed have the effect of lowering the average reflectance of the pixel as perceived by a viewer. This is seen by simply applying short drive pulses to the liquid crystal material. The reduced reflectance can be perceived and measured, for example as described below.

The fact that the perturbation pulses 61 drive the pixel into a transient state is evident from the fact that reflectance of the pixel returns to that of the planar state after the perturbation pulses 61 cease. Thus the effect of the perturbation pulses 61 may be considered as perturbation of the planar state. The energy of the perturbation pulses 61 should not be great enough to drive the liquid crystal material into a stable state of lower reflectance than the planar state. Similarly, the spacing between the perturbation pulses 61 should not be so small that two or more successive perturbation pulses 61 drive the liquid crystal material into such a stable state

The actual energy and spacing of the perturbation pulses 61 necessary to achieve this perturbation effect varies depend on the temperature and the parameters of the cell 10 such as the thickness and properties of the liquid crystal material. However, a suitable duration and spacing of the perturbation pulses 61 can be determined experimentally by tests performed on an actual cell 10 in given conditions.

The energy of the perturbation pulses 61 is controlled by their duration and amplitude. For convenience in the design of the control circuit 22, the perturbation pulses 61 may have the same amplitude as the drive pulse 50 of the homeotropic drive scheme, but this is not essential as the effect is achieved by use of a different amplitude. Typically the perturbation pulses 61 have a duration of at most 0.5 ms, preferably at most 0.2 ms, more preferably at most 0.1 ms. Typically, the perturbation pulses 61 have a spacing of at least 11.0 ms or at least 1.5 ms.

In FIG. 19, each perturbation pulse 61 is shown as having the same duration equal to an entire time slot of 0.1 ms. In this case, the number of perturbation pulses 61 is varied to vary the reflectance of the pixel. As an alternative to each perturbation pulse 61 having the same duration, the energy of the perturbation pulses 61 may be varied. This may be achieved by varying either the duration or the amplitude of the perturbation pulses 61 as shown by the arrows in FIG. 10, or indeed both the duration and amplitude of the perturbation pulses 61. The energy of the perturbation pulses 61 may be varied instead or as well as varying the number of perturbation pulses 61.

Of course to achieve the maximum reflectance there are no perturbation pulses 61 so the pixel is in the planar state for the entire cycle and has the reflectance of the planar state.

For example, the example drive signal of FIG. 10 was applied to the same actual liquid crystal cell 10 as that tested to produce the results of FIG. 9 and the resultant reflectance was measured. In this example, the perturbation pulses 61 were spread evenly over the duration of the cycle and there were applied a maximum number of eleven perturbation pulses 61 having a minimum spacing of 1.7 ms. The results are plotted in FIG. 11 which is graph of the measured reflectance against the number of perturbation pulses 61. For comparison, there is also plotted (1) the graph of FIG. 9 which shows the effect of the homeotropic drive scheme of FIG. 8 on the same cell 10 and (2) the reflectance of the planar state. It can be seen from FIG. 11 that the perturbation drive scheme allows the pixel to be driven to achieve an average reflectance as perceived by the viewer which is above that achievable by the homeotropic drive scheme. In the example of FIG. 11 this is achieved by use of between one and four perturbation pulses 61 each of duration 0.1 ms. Thus the perturbation drive scheme is used to achieve reflectances in the second portion 56. To increase the number of reflectances achievable, it is possible to use perturbation pulses which are each of lower energy (ie lower amplitude and/or lower duration), provided that the minimum spacing is maintained or else to additionally vary the energy of the perturbation pulses 61.

Thus, in overview, the combination of the perturbation drive scheme and the homeotropic drive scheme allows the pixel to be driven to have reflectances across the full range from the reflectance of the planar state to the reflectance of the planar state.

The number of the perturbation pulses, the energy of the perturbation pulses or both may be varied to vary the reflectance of the pixel over the second portion of the range of reflectances which extends from the first portion of the range achieved by the homeotropic drive scheme up to the maximum reflectance. Thus it is possible to drive a cholesteric liquid crystal display at video rates whilst achieving the advantage of providing a good contrast ratio and colour gamut as compared to a static drive scheme in which a pixel is driven into the focal conic state as the dark state. Considering such a static drive scheme, the focal conic state scatters light typically having a reflectance of from 3% to 4%. As a result the contrast ratio of the liquid crystal layer 19 is typically from 10 to 15, and with a conventional multiplex addressing electrode arrangement this gives an overall contrast ratio for the cell 10 of from about 6 to 8. However, use of the present drive scheme allows use of the homeotropic state as the dark state. As the homeotropic state has a very low reflectance, this improves the contrast ratio. For example, the contrast ratio of the liquid crystal layer 19 is typically 50 or above and the contrast ratio of the overall display device 24 in which the fill factor of the drive electrodes 31 (i.e. the area of the drive electrodes as a proportion of the area of the display) of 95% is about 30.

The colour gamut is also better as follows. In general in a cholesteric display device consisting typically of three stacked cells, the colour of each pixel within a cell is influenced by those pixels above and below it. For example if the lowest pixel has to be at its 100% colour then the pixels above it must be in a transparent state to show the lower pixel optimally. With a known static drive scheme, when the upper pixels are switched into the focal conic state which is largely transparent but not fully transparent, the lower pixels will show a colour that is a mixture of the 100% colour and some white light scattered from upper (or lower) layers. In other words the colour is less saturated than is ideal and the colour gamut is degraded. However, the use of the dynamic drive scheme allows the dark state to have a lower reflectance, hence improving the colour gamut and providing purer colours.

In both the homeotropic drive scheme and the perturbation drive scheme described above, all the drive pulses, that is the drive pulses 50 and the perturbation pulses 61 are shown as unipolar pulses. In general it is preferred that the pulses are DC balanced to limit electrolysis of the liquid crystal layer 19 which can degrade its properties over time. Such DC balancing may be achieved by the use of pulses which are of alternating polarity in successive cycles. Alternatively, any of these drive pulses may alternatively by balanced DC pulses (that is two pulses of opposite polarity) or AC pulses.

Various modifications to the drive scheme described above may be made. One possibility is for the waveform in any given cycle to be adapted based on the waveform applied in the previous cycle.

1. A method of driving a cholesteric liquid crystal display device which comprises at least one cell comprising a layer of cholesteric liquid crystal material and an electrode arrangement capable of providing independent driving of a plurality of pixels across the layer of cholesteric liquid crystal material by respective drive signals, the method comprising applying respective drive signals to each pixel in successive cycles of predetermined duration to drive the pixels into states which are varied to provide a reflectance varying within a predetermined range of reflectances,
the drive signal for at least some of the pixels comprises a waveform including a number of perturbation pulses which are of sufficiently low energy and sufficiently spaced from each other that the pixel is driven into a transient state having a lower reflectance than the planar state, the overall energy of the number of the pertubation pulses being variable to provide a varying average reflectance as perceived by a viewer.

2. A method according to claim 1, wherein the perturbation pulses have a duration of at most 0.5 ms, preferably at most 0.2 ms, more preferably at most 0.1 ms.

3. A method according to claim 1, wherein the number of the pertubation pulses is variable to provide a varying average reflectance as perceived by a viewer.

4. A method according to claim 3, wherein the perturbation pulses are each of the same energy.

5. A method according to claim 1, wherein the perturbation pulses are of a variable energy to provide a varying average reflectance as perceived by a viewer.

6. A method according to claim 1, wherein the waveform comprises a relaxation period sufficient to cause the pixel to relax into the planar state in the event that the pixel is initially in the homeotropic state, followed by said number of perturbation pulses.

7. A method according to claim 1, wherein the drive signals comprise within each respective cycle:
(a) when providing a reflectance in a first portion of the predetermined range of reflectances, a second waveform comprising
one or more drive pulses shaped to drive the pixel into the homeotropic state,
alternating with one or more relaxation periods to cause the pixel to relax into the planar state, the periods of time during which the pixel is driven into the homeotropic and planar states being variable to provide a varying average reflectance as perceived by a viewer; and
(b) when providing a reflectance in a second portion of the predetermined range of reflectances above the first portion, said first mentioned waveform.

8. A method according to claim 7, wherein said second waveform comprises, in each of a plurality of cycles of predetermined duration, a single drive pulse shaped to drive the pixel into the homeotropic state followed by a relaxation period to cause the pixel to relax into the planar state.

9. A method according to claim 7, wherein the drive signals further comprise within each respective cycle:
(c) when providing the minimum reflectance of the predetermined range of reflectances, a third waveform comprising a drive pulse shaped to drive the pixel into the homeotropic state for the entire cycle.

10. A method according to claim 1, wherein each cycle is notionally divided into predetermined time slots, the one or more drive pulses and the pertubation pulses each occupying whole time slots.

11. A method according to claim 1, wherein each of the pulses is a DC pulse, a balanced DC pulse or an AC pulse.

12. A method according to claim 1, wherein the electrode arrangement includes a respective conductive layer on each side of the layer of liquid crystal material, at least one of the conductive layers being patterned to provide a plurality of separate drive electrodes each capable of providing independent driving an area of the layer of liquid crystal material adjacent the respective drive electrode as one of said pixels.

13. A method according to claim 12, wherein one of the conductive layers is patterned to provide said plurality of separate drive electrodes and the other of the conductive layer is shaped as at least one common electrode extending over a plurality of pixels.

14. A method according to claim 12, wherein the electrode arrangement further comprises a separate track connected to each of the separate drive electrodes and extending to a position outside the array of addressable pixels where the tracks form terminals each capable of receiving a respective drive signal.

15. A method according to claim 12, wherein the at least one cell comprises two substrates defining therebetween a cavity in which said a layer of liquid crystal material is disposed, the respective conductive layers each being formed on one of the substrates

16. A method according to claim 1, wherein the plurality of pixels comprises a two-dimensional array of pixels.

17. A method according to claim 1, wherein the successive cycles have a duration of at most 30 ms.

18. A cholesteric liquid crystal display device comprising:
at least one cell comprising a layer of cholesteric liquid crystal material and an electrode arrangement capable of providing independent driving of a plurality of pixels across the layer of cholesteric liquid crystal material by respective drive signals,
a drive circuit arranged to apply respective drive signals to each pixel in successive cycles of predetermined duration to drive the liquid crystal material of the pixels into states which are varied to provide a reflectance varying within a predetermined range of reflectances, the drive signal for at least some of the pixels comprises a waveform including a number of perturbation pulses which are sufficiently short and sufficiently spaced from each other that the pixel is driven into a transient state having a lower reflectance than the planar state, either or both of the number of the pertubation pulses and the width of the perturbation pulses being variable to provide a varying average reflectance as perceived by a viewer.

19. A cholesteric liquid crystal display device according to claim 18, wherein the waveform comprises a relaxation period sufficient to cause the pixel to relax into the planar state in the event that the pixel is initially in the homeotropic state, followed by said number of perturbation pulses.

20. A cholesteric liquid crystal display device according to claim 18, wherein the drive signals comprise within each respective cycle:
(a) when providing a reflectance in a first portion of the predetermined range of reflectances, a second waveform comprising
one or more drive pulses shaped to drive the pixel into the homeotropic state,
alternating with one or more relaxation periods to cause the pixel to relax into the planar state, the periods of time during which the pixel is driven into the homeotropic and planar states being variable to provide a varying average reflectance as perceived by a viewer; and
(c) when providing a reflectance in a second portion of the predetermined range of reflectances above the first portion, said first mentioned waveform.
